(19) United States
(12) Patent Application Publication
(10) Pub. No.: US 2007/0199619 A1
(43) Pub. Date: Aug. 30, 2007

(54) Fence and its fixing device

(76) Inventor: Fu-Yao Cheng, Tung-Kang Town (TW)

Correspondence Address: J.C. Patents, Suite 250, 4 Venture, Irvine, CA, 92618, US

(21) Appl. No.: 11/415,815

(22) Filed: May 1, 2006

Related U.S. Application Data
(63) Continuation-in-part of application No. 11/357,804, filed on Feb. 16, 2006.

(51) Int. Cl. B27C 5/10

(52) U.S. Cl. 144/136.95

(57) ABSTRACT

A fence is made integral of plastic foam material by injecting molding, having an inner shock-enduring layer contained in the interior, and shaped corrugated to have a plurality of lengthwise convex ridges and lengthwise concave recesses alternately connected with each other, with a light reflecting strip or dot adhered on each ridge. The fixing device of the fence includes a fixing base and a fixing block, and the fixing base is provided with a fence-contacting surface for combining with the fence. The fixing block is fixed with a bolt on a front surface of the fence at the spot where the fence is to be fixed with the vertical post, with the fixing base placed behind the fence. Thus the fence can be installed stably at two sides of a road,

### BACKGROUND OF THE INVENTION

1. Field of the Invention

This invention relates to a fence and its fixing device, particularly to one made of plastic foam material with shock-enduring property for positioned stably at two sides of a road by means of the fixing device, and its fixing work is quick and simple,

2. Description of the Prior Art

A conventional fence fixed at two sides of a road shown in FIG. 1 includes a fence 1 made of metal and a post 11. The fence 1 is provided with plural boltholes 10 for bolts 13 to tighten the fence with the post 11, with a buffer block 212 sandwiched between the fence 1 and the post 11. But the metal fence 1 may be limited in its length, and it takes much time in fixing the fence 1 with the post 11, which is made of concrete, metal, wood, etc. and concrete may be the preferable material for the post 11 because of its anti-corrosion. The buffer block 12 is made of wood, having buffering function for the fence 1.

However, the conventional fence and its fixing device have been found to have the following disadvantages.
1. The metal fence 1 is devoid of elasticity, and easily bends in case of shock a car receives, having a potential danger for persons and cars, Moreover, a reflective strip is not easily attached on its surface, so reflective paint has to be used, but reflective paint may be liable to peel off.
2. In fixing the fence with the post, the bolt and nut 13 and a buffer block 12 are used, but the buffer block 12 is made of wood, easily rotten by means of elements, resulting in a problem of replacing it even if it might not be hit to break off.
3. In positioning it at two sides of a road, much workload is necessary for combining the fence, the post and the buffer block, delaying the work.

### SUMMARY OF THE INVENTION

The inventin has the following features.
1. The fence is made integral of plastic foam material, having a plurality of light reflecting strips or spots on its outer surface, containing an shock-enduring layer for boosting enduring force to shocks, not easily rifting and making it very safe to humans and cars.
2. The fixing device of the fence consists of a fixing base, a fixing block and a post, The fixing base is combined with the post first, and then the fence is fixed with the fixing base, saving assembling work and quickening its work.
3. The fixing base is provided with a fence-contacting surface for fixing with the fence tightly, and with a post-contacting surface for fixing with the post tightly. So the fence can be assembled with the fixing base and the post together with easiness and quickness.

### BRIEF DESCRIPTION OF DRAWINGS

This invention will be better understood by referring to the accompanying drawings, wherein:

FIG. 1 is an exploded perspective view of a conventional fence and its fixing device;

FIG. 2 is a cross-sectional view of a first embodiment of a fence in the present invention;

FIG. 3 is a perspective view of the first embodiment of a fence fixed on a post in the present invention;

FIG. 4 is a cross-sectional view of a second embodiment of a fence in the present invention;

FIG. 5 is a perspective view of the second embodiment of a fence fixed with a post in the present invention;

FIG. 6 is a cross-sectional view of a third embodiment of a fence in the present invention;

FIG. 7 is a cross-sectional view of a fourth embodiment of a fence in the present invention;

FIG. 8 is a cross-sectional view of a fifth embodiment of a fence in the present invention;

FIG. 9 is a cross-sectional view of a sixth embodiment of a fence in the present invention;

FIG. 10 is a cross-sectional view of a seventh embodiment of a fence in the present invention;

FIG. 11 is a cross-sectional view of the fence in the present invention receiving a shock;

FIG. 12 is an exploded perspective view of a first embodiment of a fixing device for the fence in the present invention;

FIG. 13 is a cross-sectional view of the first embodiment of a fixing device combined with the fence in the present invention;

FIG. 14 is a perspective view of the first embodiment of a fixing device combined with the fence in the present invention;

FIG. 15 is a perspective view of the first embodiment of a fixing device combined with two fences in the present invention;

FIG. 16 is an exploded perspective view of a second embodiment of a fixing device in the present invention;

FIG. 17 is a perspective view of the second embodiment of a fixing device combined with the fence in the present invention;

FIG. 18 is a perspective view of the second embodiment of a fixing device combined with two fences in the present invention;

FIG. 19 is an exploded perspective view of a third embodiment of a fixing device in the present invention; and,

FIG. 20 is a perspective view of the third embodiment of a fixing device combined with two fences in the present invention.

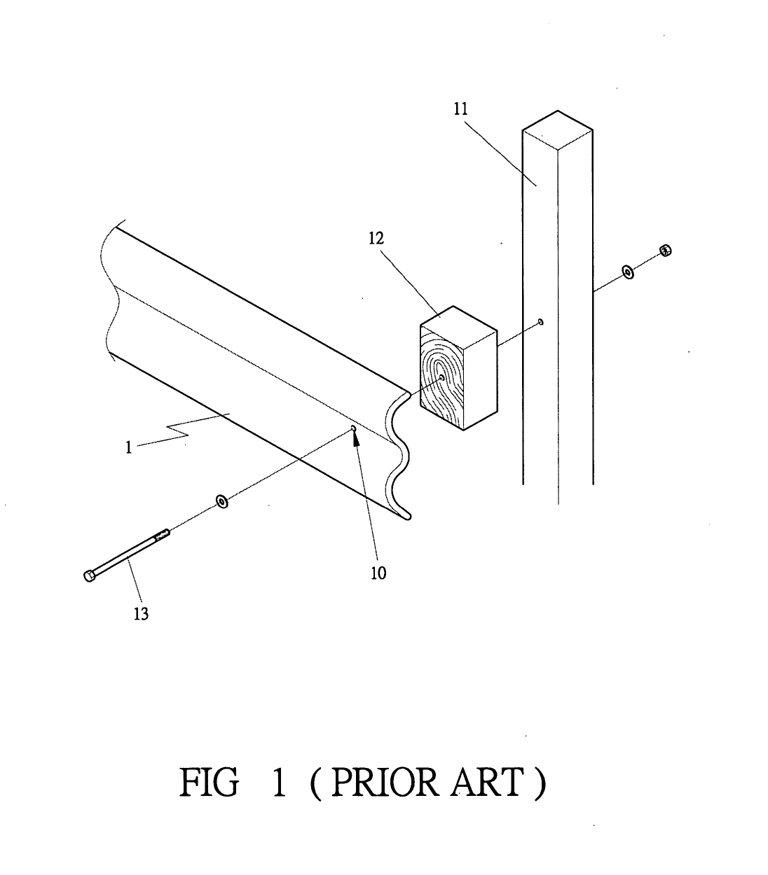

### DETAILED DESCRIPTION OF THE PREFERRED EMBODIEMNTS

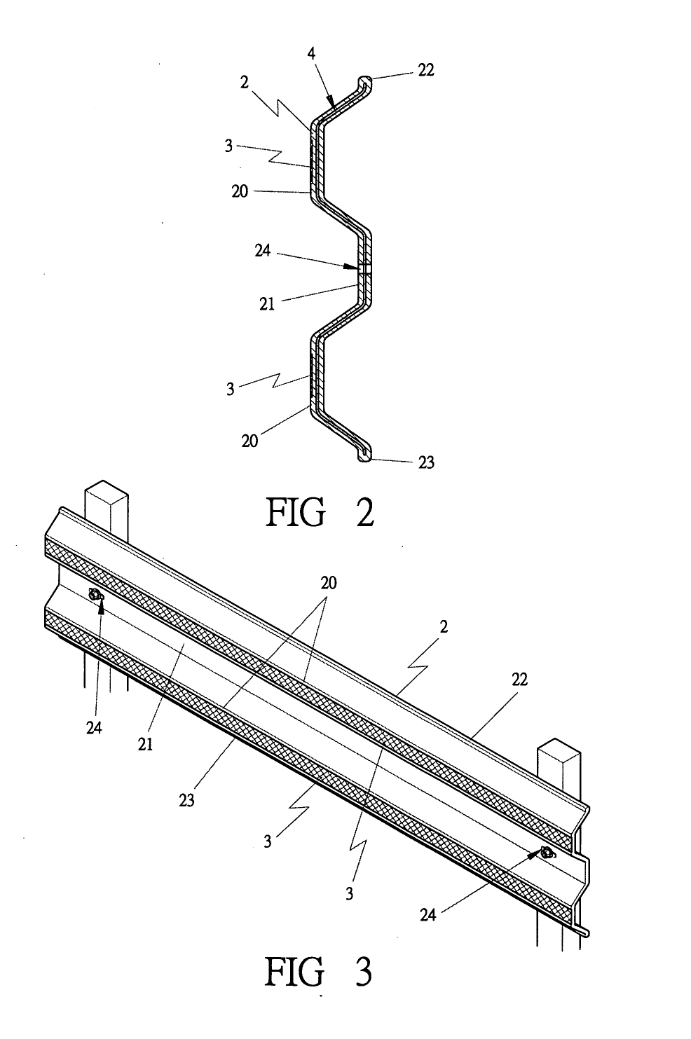

A first preferred embodiment of a fence in the present invention, as shown in FIGS. 2 and 3, includes a fence 2 shaped corrugated, having a plurality of lengthwise convex ridges 20 and a plurality of concave recesses 21 alternate with each other, and a light reflective strip 3 attached on each convex ridge 20. Further the fence 2 has an upper lengthwise end 22, a lower lengthwise end 23, and a bolt hole 24 bored through each recess, and an inner shock-enduring layer 4 formed in its interior.

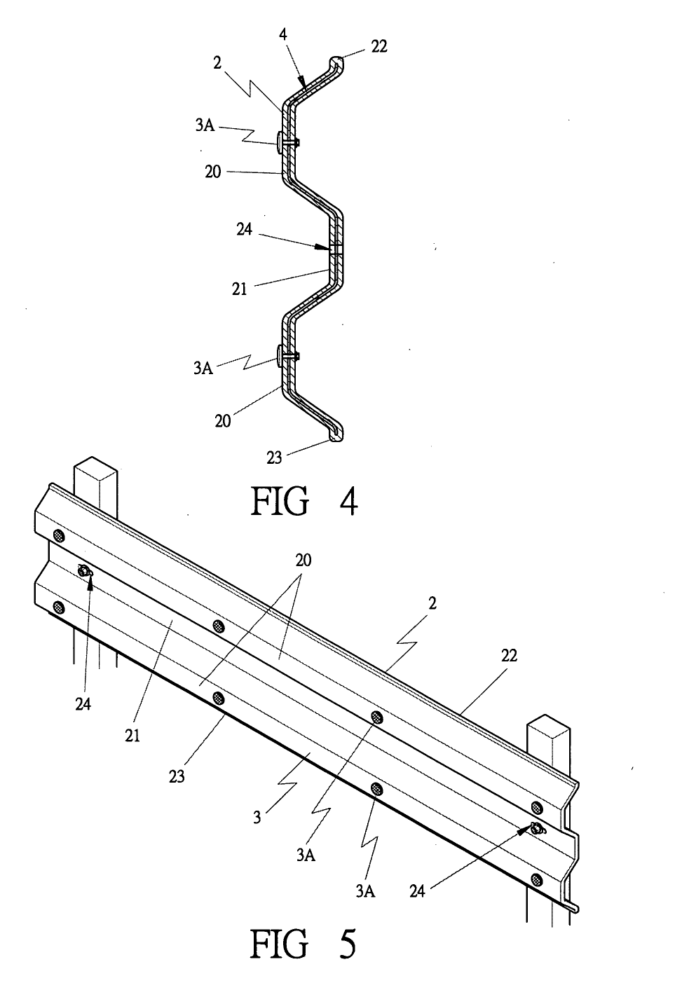

Next, a second preferred embodiment of a fence in the present invention is shown in FIGS. 4 and 5, including a fence 2 also corrugated and provided with a plurality of convex ridges 20 and a plurality of concave recesses 21 as the first preferred embodiment, and a plurality of light reflecting dots 3A attached on each bolt engaging with the fence 2. Further, the fence 2 is provided with an inner shock-enduring layer 4 in the same way as the first embodiment.

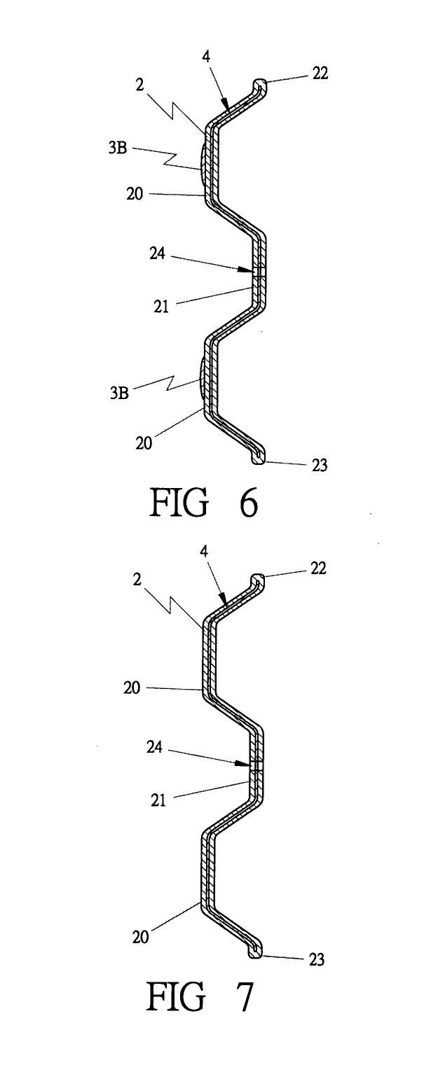

A third preferred embodiment of a fence in the present invention is shown in FIG. 6, includes a fence 2 provided with a plurality of convex ridges 20 and a plurality of concave recesses 21 as the second preferred embodiment, and a plurality of light reflecting strips or dots 3B attached and spaced apart on the ridges 20.

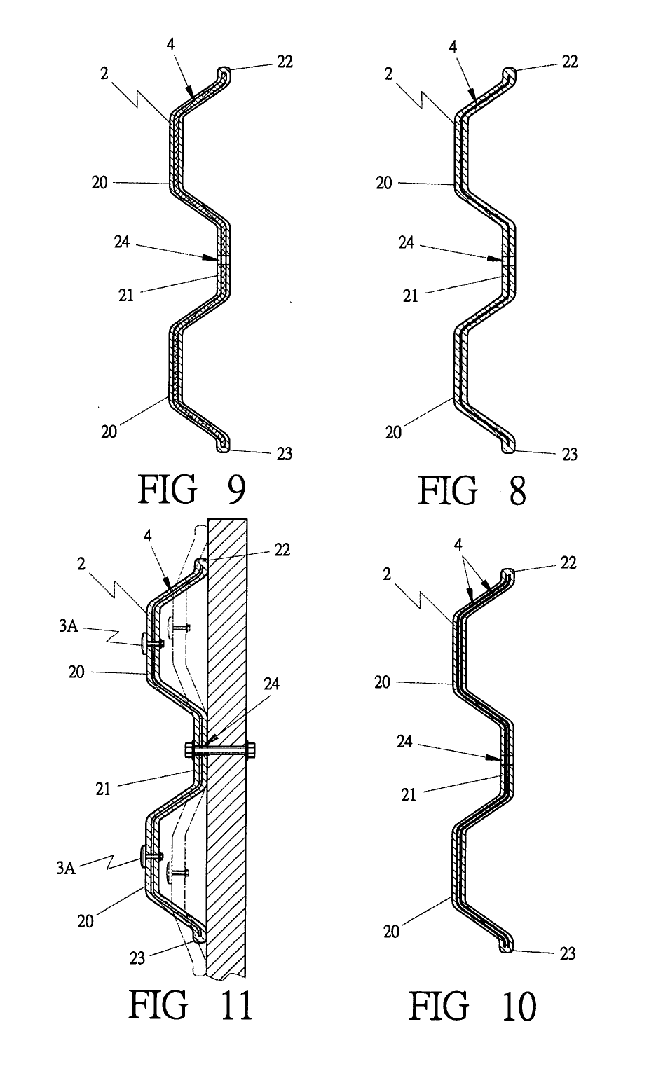

Next, FIGS. 7, 8, 9 and 10 shows respectively a fourth, a fifth, a sixth and a seventh preferred embodiment of the fence in the present invention, modified from the first, the second and the third embodiment with a difference that light reflecting strips or dots 3, 3A, or 3B are not used, but the material of the fence is mixed with light reflecting material so that the fence itself can reflect light.

Moreover, each embodiment of a fence is provided with the inner shock-enduring layer 4, and the layer 4 can be single as shown in FIGS. 2-9, or plural as shown in FIG. 10, made of any material, but preferably fiber, metal nets, plastic nets, metal pieces, or linear ones, so long as it has substantive elasticity and flexibility.

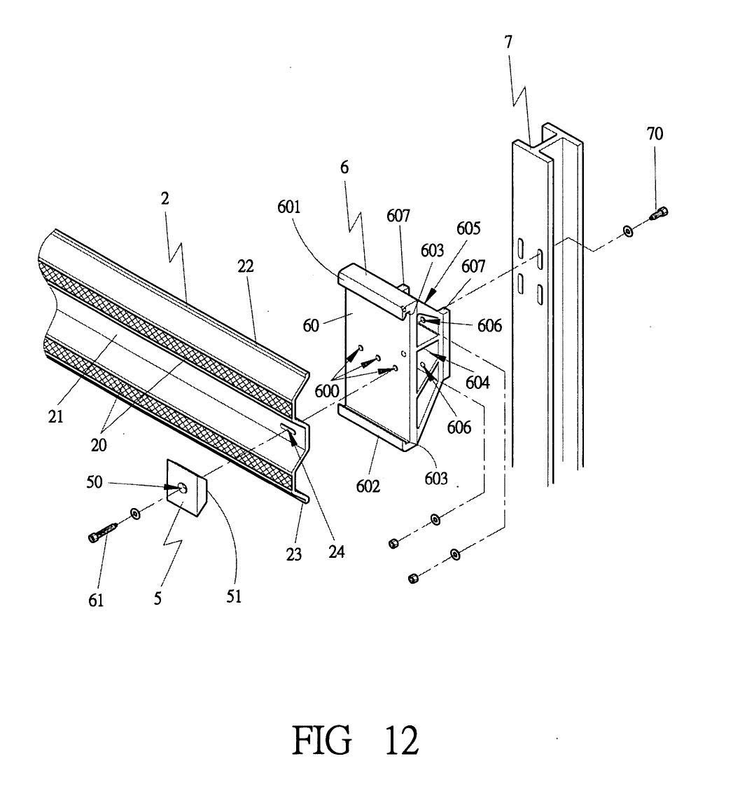

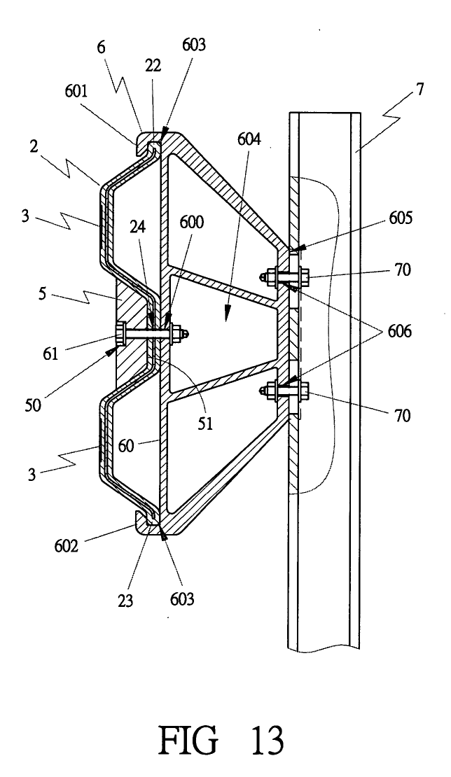

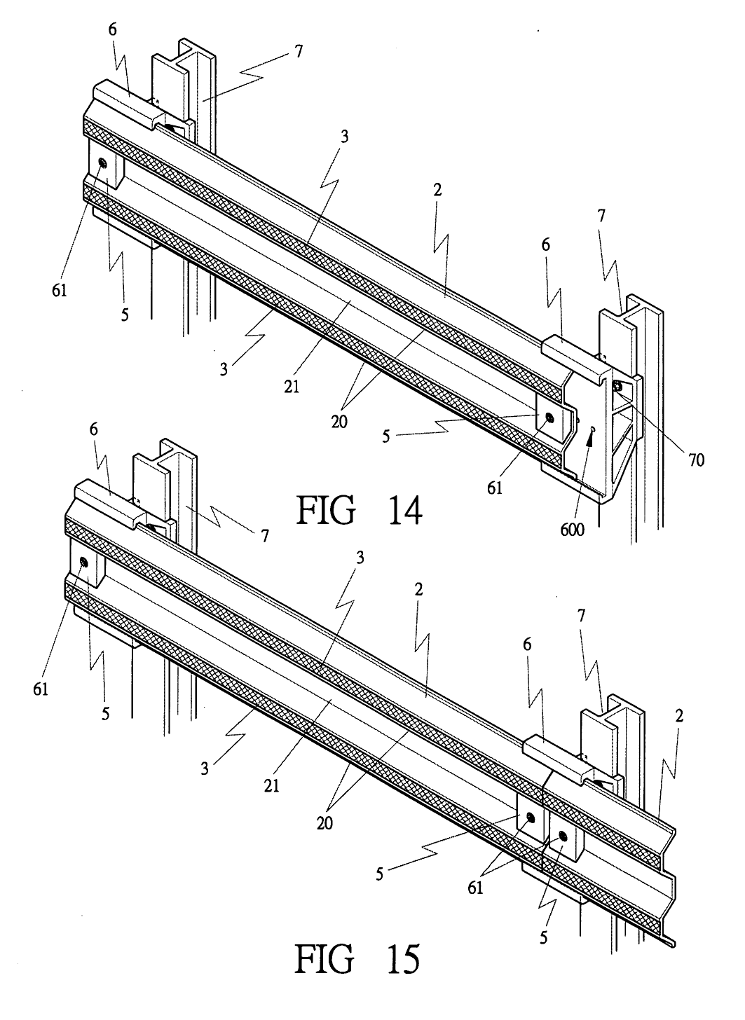

Next, a first preferred embodiment of a fixing device for the fence in the present invention, as shown in FIGS. 12, 13, 14 and 15, includes a fixing block 5, and a fixing base 6.

The fixing block 5 is provided with a through hole 50, and an inner curved surface 15 to suit to the surface of the fence 2 so as to enable the fixing block 5 tightly contact with the fence 2.

The fixing base 6 is provided with a fence contacting surface 60, a holes 600 formed in the fence contacting surface 60 for a bolt 61 to pass through the through holes 50 of the fixing block 5 and further through the hole 24 of the fence 2 so that the fixing base 60 may be accurately combined with the fence 2, and also connecting two fences 2 with each other, if necessary. Further, the fixing base 6 is provided with an upper edge 601 and a lower edge 602, and a groove 603 is formed between the upper edge 601 and the contact surface 60 and also between the lower edge 602 and the contact surface 60. Then the upper end 22 and the lower end 23 of the fence 2 can fit just in the groove 603 in case of combining them together for convenience of screwing work. Further, a hollow 604 of a proper width is formed in the interior of the fixing base 6, letting a tool or a hand to extend there in for screwing. Moreover, the fixing base 6 is provided with a lower flat surface 605 for contacting closely with the surface of the post 11, and the lower flat surface 605 is provided with a rectangular hole 606 and two sidewalls 607. The rectangular hole 606 is for adjusting the error of the height of the post 11 after buried in the ground for the bolt 70 to be screwed with the post 11 properly, and the two sidewalls 607 are for smooth combination of the fixing base 6 with the post 7 and for correcting the position of the fixing base 6 relative to the post 11.

In assembling the fence with the post, the fixing base 6 is in advance combined with the post 7, and then the fence 2 is combined with the fixing base 6. Therefore, the assembling work can be carried out smoothly and quickly.

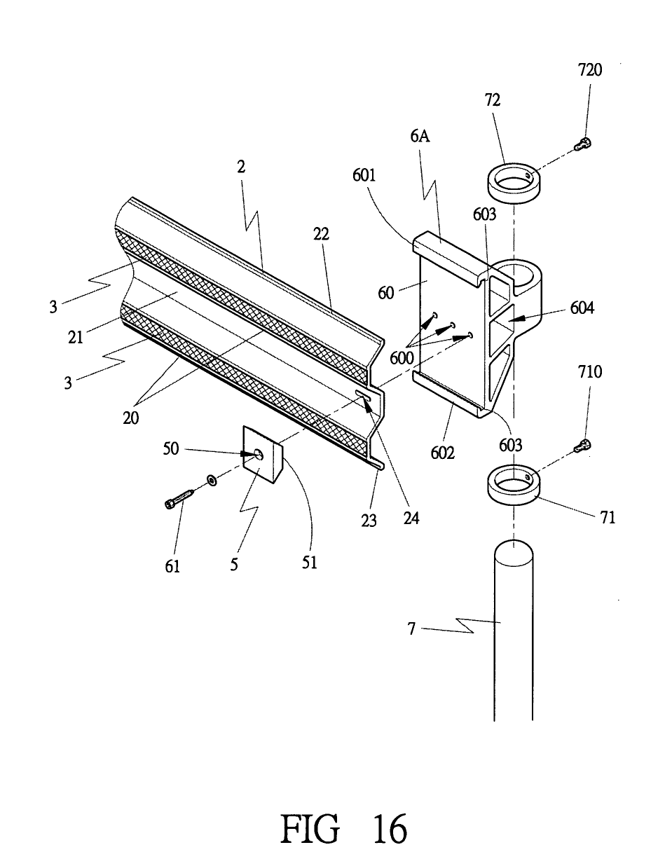

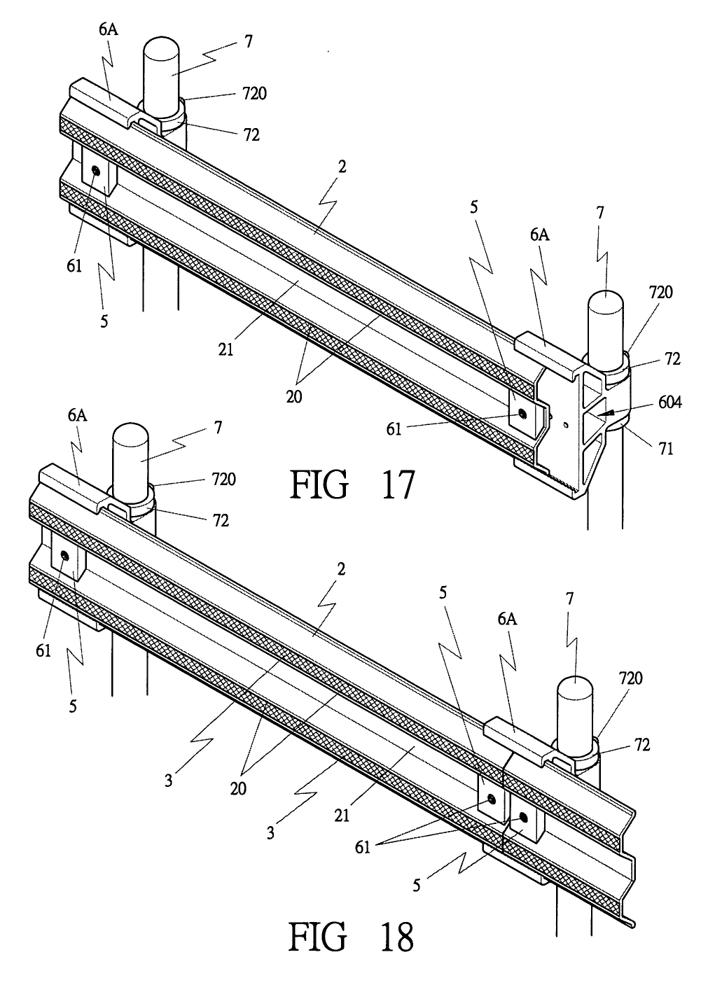

Next, FIGS. 16, 17 and 18 show a second preferred embodiment of a fixing device in the present invention, which is derived from the first embodiment, having a difference that a fixing base 6A is provided with a post hole 608 for a round post 7 to pass through, but the round post 7 has to pass through a fixing ring 71 first, and then a bolt 710 is used to tighten the fixing ring 71 to the round post 7, and then another fixing ring 72 is fitted around and tightened by a bolt 720 with the upper exposed portion of the post 7 on the fixing base 6A, finishing combining the fixing base 6A with the post 7.

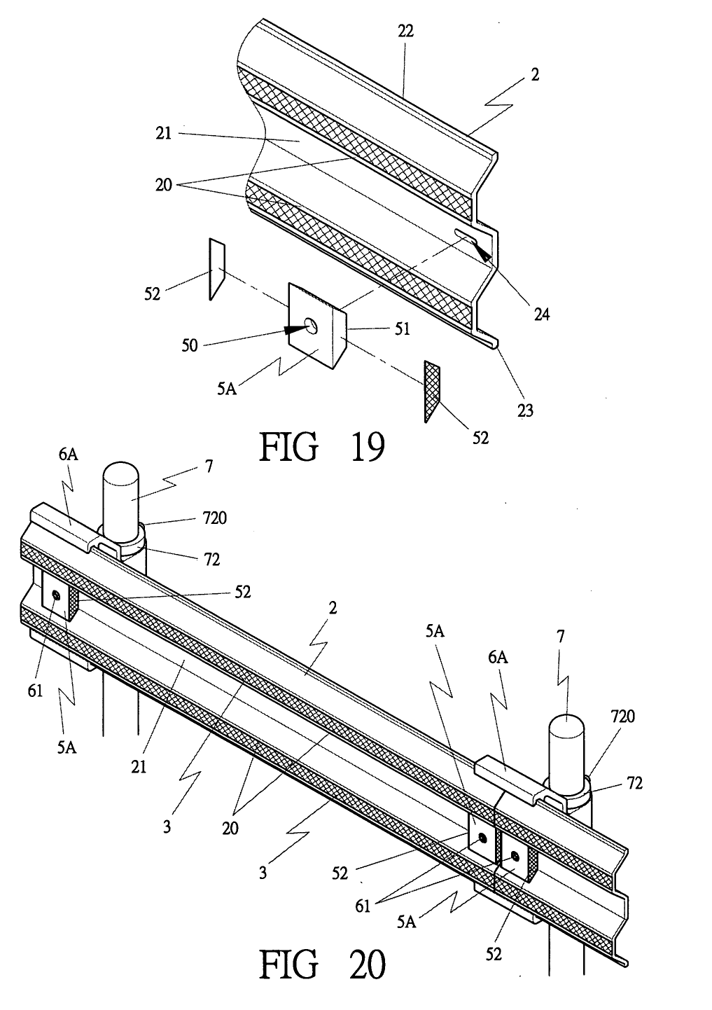

Further, FIGS. 19 and 20 show a third preferred embodiment of a fixing device in the present invention. The difference of the third preferred embodiment from the first and the second one is a light reflecting dot 52 is attached respectively on two sides of a fixing block 5A, beefing up light reflecting effect for more safety of the for cars and persons.

The light reflecting strips or dots provided in the fence in the invention hardly fall off, extremely effective in a remote area or an area installed with no road lamps. Besides, the fence is made integral of plastic foam material by means of injecting molding, characterized by shock absorbing property, light reflecting function, and not falling off of the light reflecting strips or dots.

While the preferred embodiments of the invention have been described, it will be recognized that various modifications may be made therein and the appended claims are intended to cover all such modifications that may fall within the spirit and scope of the invention.

1. A fence made integral of plastic foam material and having a corrugated shape with a plurality of lengthwise convex ridges and a plurality of lengthwise concave recesses alternately connected each other, a light reflecting strip formed integral on each said ridge to provide said fence with a light reflecting function; an inner shock-enduring layer contained in said fence during its injecting molding so that said fence is substantively elastic, and not to be easily broken or rifled to have a safety function for protecting persons or cars.

2. A fence and its fixing device comprising:
a fence provided with an upper lengthwise end, a lower lengthwise end and a plurality of bolt holes;
a fixing block bored with a through hole;
a fixing base having a fence contacting surface, a hole formed in said fence contacting surface for a blot to tighten said fixing block and said fence with said fixing base, said fence contacting surface having an upper edge and a lower edge; said fixing base further provided with a side through hole and a post contacting surface for tightly combining with a post;
said fixing base firstly fastened with said post with a bolt, said fence then fixed with said fixing base so that said post, said fixing base and said fence may be tightly combined all together.

3. A fence and its fixing device comprising:
a fence provided with an upper lengthwise end, a lower lengthwise end and a plurality of bolt holes;
a fixing block bored with a through hole;
a fixing base provided with a fence contacting surface, said fence contacting surface having a hole for a bolt to pass through to tighten said fixing block and said fence with said fixing base, said fence contacting surface provided with an upper edge and a lower edge, said fixing base further having a side through hole and a post hole for a post to vertically pass through, an upper fixing ring fitted around an upper portion of said post and a lower fixing ring fitted around a lower portion of said post, a bolt engaging through said upper and said lower fitting ring to tightly fix said upper and said lower fitting ring to said post for fixing tightly said fixing base with said post;
said fixing base firstly fixed with said post with said bolt, said fence then fixed with said fixing base so that said fence, said fixing base and said post may be tightly combined all together.

4. The fence and its fixing device as claimed in claim 2, wherein said fixing block is provided with an inner surface conformed to the shape of the surface of said fence so that said fixing block may contact closely with said post.

5. The fence and its fixing device as claimed in claim 2, wherein said fixing block has a light reflecting dot attached respectively on its two sides.

6. The fence and its fixing device as claimed in claim 2, wherein said fixing base is provided with a groove between said upper edge and said fence contacting surface, and between said lower edge and said contacting surface, so said upper end and said lower end of said fence may fit in said grooves first for convenience of subsequent assembling work.

7. The fence and its fixing device as claimed in claim 2, wherein said post contacting surface of said fixing base is provided with a rectangular hole and two sidewalls so that said fixing base may be corrected in its location to said post so as to cope with an error of the height of said post after buried in the ground, and may be combined with said post smoothly and accurately.

8. The fence and its fixing device as claimed in claim 3, wherein said fixing block is provided with an inner surface conformed to the shape of the surface of said fence so that said fixing block may contact closely with said post.

9. The fence and its fixing device as claimed in claim 3, wherein said fixing block has a light reflecting dot attached respectively on its two sides.

10. The fence and its fixing device as claimed in claim 3, wherein said fixing base is provided with a groove between said upper edge and said fence contacting surface, and between said lower edge and said contacting surface, so said upper end and said lower end of said fence may fit in said grooves first for convenience of subsequent assembling work.
